(19) United States
(12) Patent Application Publication
(10) Pub. No.: US 2014/0124328 A1
(43) Pub. Date: May 8, 2014

(54) METHOD AND APPARATUS FOR GENERATING LASER

(71) Applicant: Tak Woo, Daegu (KR)

(72) Inventor: Tak Woo, Daegu (KR)

(21) Appl. No.: 14/126,820

(22) PCT Filed: Jun. 14, 2012
(86) PCT No.: PCT/KR2012/004683

§ 371 Date: Dec. 17, 2013

(30) Foreign Application Priority Data
Jul. 19, 2011 (KR) 10-2011-0071514

(51) Int. Cl. B66B 29/00

(52) U.S. Cl. CPC B66B 29/00
USPC 198/323

(57) ABSTRACT

Disclosed herein is a side safety device for an escalator which is operated in such a way that a plurality of stairs circulates. The side safety device includes a side safety plate (100) which is coupled to each of side surfaces of each of the stairs (2) at a position adjacent to a vertical plate (2b) of the stair. The side safety plate has a triangular shape and protrudes forwards from the vertical plate. The side safety plate includes a bottom side (104) which extends parallel to a step board (2a) of the stair in a direction away from the stair, and a hypotenuse (106) which extends at a predetermined inclination so as to meet the bottom side. The inclination of the hypotenuse is substantially equal to an inclination of an inclined section of the escalator.

### CROSS-REFERENCE TO RELATED APPLICATIONS

This application is the U.S. national phase of International Patent Application No. PCT/KR2012/004683 filed Jun. 14, 2012, which claims the benefit of Korean Patent Application No. 10-2011-0071514 filed Jul. 19, 2011, the entire content of which is incorporated herein by reference.

### FIELD OF THE INVENTION

The invention relates, in general, to escalators and, more particularly, to a side safety device for escalators which is configured to prevent part of the body of a user or an object such as clothes from being caught in a gap between an escalator stair and a handrail, and to an escalator having the side safety device.

### BACKGROUND

Generally, escalators are a transportation means which is widely used for transportation between adjacent floors in buildings such as department stores, supermarkets, airports, hotels, etc.

FIG. 1 is a schematic perspective view of a typical escalator. The escalator 1 comprises a plurality of stairs 2 which are connected to each other in a loop shape and support people thereon, handrails 3 which are provided on opposite sides of the stairs 2 and guide the stairs 2, and a drive unit (not shown) which operates the stairs 2.

A rail type grip 4 is installed on each handrail 3 to allow people (or users) who stand on the stairs 2 to grasp the grip 4 with their hands so that they can safely move on the escalator 1.

In the conventional escalator 1 having the above-mentioned construction, because a gap is present between the stairs 2 and each handrail 3, there is the possibility of an accident in which, for example, shoes or the like are caught in the gap when the stairs 2 move upwards or downwards.

In other words, when the stairs 2 move upwards, a shoe or the like may be caught between a step board 2a provided on an upper surface of the corresponding stair 2 and the handrail 3. When the stairs 2 move downwards, a shoe or the like may be caught between a vertical plate 2b provided on a front surface of the corresponding stair 2 and the handrail 3. Such accidents frequently occur.

In addition to shoes, items such as clothing, waste debris or other objects placed on the upper surface of a stair may be caught in such a gap, thus causing an accident or leading to malfunction of the escalator.

Moreover, when a child falls on the escalator, there is a risk of an accident in which his/her finger or the like is caught between a stair 2 and the handrail 3.

### SUMMARY

The invention has been made keeping in mind the above problems occurring in the prior art, and an object is to provide a side safety device for escalators which is configured to prevent part of the body of a user or an object such as clothing from being caught in a gap between an escalator stair and a handrail, and to an escalator having the side safety device.

In order to accomplish the above object, an embodiment provides a side safety device for an escalator in which a plurality of stairs circulate in a circulation belt manner between upper and lower rollers having a height difference.

The side safety device comprises a side safety plate which is coupled to each of side surfaces of each of the stairs at a position adjacent to a vertical plate of the stair. The side safety plate has a triangular shape and protruding forwards from the vertical plate.

The side safety plate having the triangular shape comprises a bottom side extending parallel to a step board of the stair in a direction away from the stair, and a hypotenuse extending at a predetermined inclination so as to meet the bottom side. The inclination of the hypotenuse is substantially equal to that of an inclined section of the escalator.

In the inclined section of each of the stairs, the bottom side may be level with an upper surface of the step board of the following stair adjacent to the vertical plate of the stair.

The side safety plate may extend such that a distal end of the side safety plate is disposed at a position spaced apart from a boundary between the step board and the vertical plate of the following stair by a predetermined distance.

The side safety device may further comprise an elastic deformation member provided on an upper end of the side safety plate. The elastic deformation member extends along the hypotenuse. The inclination of an upper surface of the elastic deformation member may be equal to that of the inclined section of the escalator. The elastic deformation member may be made of material having at least one characteristic among elasticity, ductility and flexibility.

A distal end of the side safety plate may extend to a boundary between the step board and the vertical plate of the following stair adjacent to the vertical plate of the stair. The side safety plate may be made of material having at least one characteristic among elasticity, ductility and flexibility.

The side safety plate may be provided so as to be rotatable relative to the vertical plate of the stair by a predetermined angle around a point adjacent to an upper end thereof at which the bottom side and the hypotenuse meets. The side safety device may further comprise: a shaft connecting the side safety plate rotatably to the vertical plate of the stair at the point adjacent to the upper end of the side safety plate; and a spring elastically connecting the side safety plate to the vertical plate of the stair at a position adjacent to the bottom side of the side safety plate.

The side safety device may further comprise: a shaft fastened to the side safety plate to rotatably connect the side safety plate to the stair at the point adjacent to the upper end of the side safety plate; and a spring fastened at a first end thereof to the side safety plate and fastened at a second end thereof to the stair so that the side safety plate is elastically connected to the stair by the spring.

The side safety device may further comprise a skirt guard protruding from an inner surface of a handrail towards the stairs and extending along the inclined section. The skirt guard may extend at an inclination equal to the inclination of the hypotenuse in such a way that a bottom surface of the skirt guard is adjacent to the hypotenuse of the side safety plate.

The side safety device may further comprise a skirt depression formed in an inner surface of a handrail towards an outer surface of the handrail, the skirt depression extending along the inclined section. The skirt depression may extend at an inclination substantially equal to the inclination of the hypotenuse in such a way that a top surface of the skirt guard is adjacent to the hypotenuse of the side safety plate.

The side safety device may further comprise a safety-plate-receiving-space defining part formed by protruding a portion of an escalator platform upwards in such a way that space is defined in the safety-plate-receiving-space defining part, whereby a distal end of the side safety plate that rotates for circulation along with the stair around a roll under the escalator platform is prevented from coming into contact with a lower surface of the escalator platform.

Another embodiment provides an escalator comprising: a plurality of stairs rotating in a circulation belt manner between upper and lower rollers having a height difference; and the side safety device.

According to the invention, part of the body of a user or an object such as clothing can be prevented from being caught in a gap between an escalator stair and a handrail. The above-mentioned purpose can be achieved without changing the design of the existing escalator.

### BRIEF DESCRIPTION OF THE DRAWINGS

FIG. 1 is a schematic perspective view of a typical escalator;

FIG. 2 is a perspective view illustrating an escalator stair provided with a side safety device according to an embodiment of the invention;

FIG. 3 is a side view of FIG. 2;

FIG. 4 is a perspective view showing a portion of an escalator having the escalator stair provided with the side safety device of FIG. 2;

FIG. 5 is a side view showing a portion of the escalator having the escalator stair provided with the side safety device of FIG. 2;

FIG. 6 is a side view showing the operation of the escalator having the escalator stair provided with the side safety device of FIG. 2;

FIG. 7 is a side view illustrating an escalator stair provided with a side safety device according to another embodiment of the invention;

FIG. 8 is a side view showing a portion of an escalator having the escalator stair provided with the side safety device of FIG. 7;

FIGS. 9 and 10 are side views showing the operation of the escalator having the escalator stair provided with the side safety device of FIG. 7;

FIG. 11 is a side view illustrating an escalator stair provided with a side safety device according to an embodiment of the invention;

FIG. 12 is a conceptual view showing the operation of a side safety device according to an embodiment of the invention;

FIG. 13 is a conceptual view showing an example to embody the side safety device of FIG. 12;

FIG. 14 is a conceptual view showing another example to embody the side safety device of FIG. 12;

FIG. 15 is a perspective view illustrating another embodiment of the escalator having the side safety device according to the invention;

FIG. 16 is a perspective view illustrating yet another embodiment of the escalator having the side safety device according to the invention;

FIG. 17 is side view showing the operation of still another embodiment of the escalator having the side safety device according to the invention; and

FIG. 18 is a front perspective view of the escalator of FIG. 17.

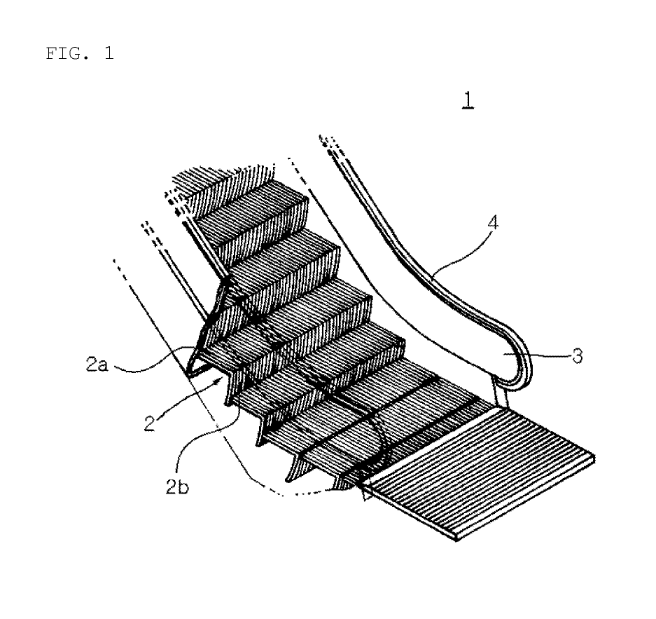

### DETAILED DESCRIPTION

Hereinafter, embodiments of a side safety device for escalators and an escalator having the side safety device will be described in detail with reference to the attached drawings.

The side safety device can be used in an escalator which transfers users from a predetermined height to another height in such a way that a plurality of stairs rotate in a circulation belt rotating manner between upper and lower rollers having a height difference. The side safety device is configured to prevent an accident in which a portion of the body of a user or a substance such as clothes is caught between an escalator stair and a handrail.

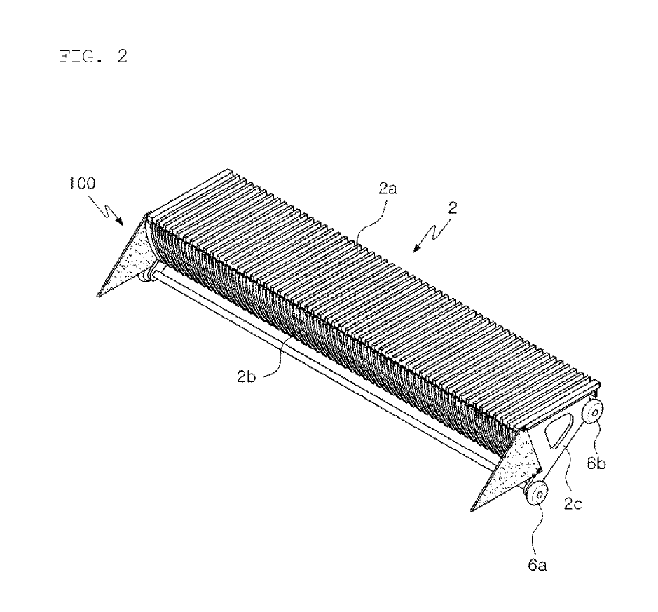

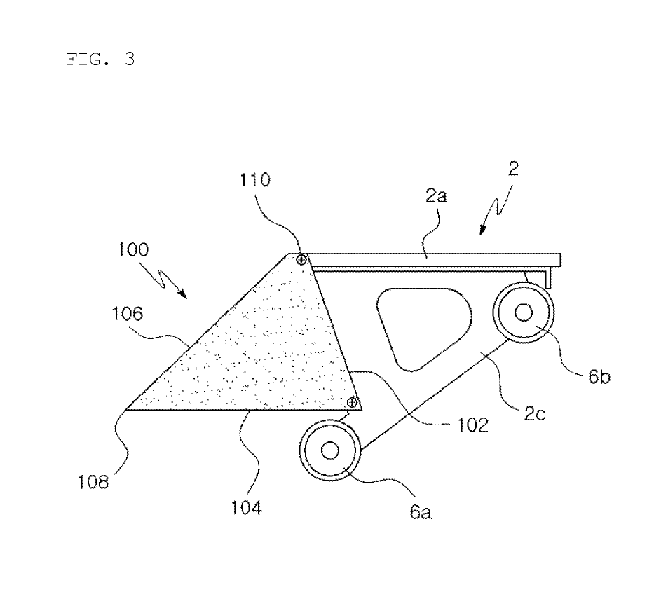

Referring to FIGS. 2 and 3, a stair 2 comprises a step board 2a and a vertical plate 2b. The stair 2 further selectively comprises a frame 2c. A lower wheel 6a and an upper wheel 6b are provided on a lower portion of the stair 2. The lower wheel 6a functions as a rear wheel in the case of an upward escalator, and it functions as a front wheel in the case of a downward escalator. On the other hand, the upper wheel 6b functions as a front wheel in an upward escalator, and it functions as a rear wheel in the case of a downward escalator.

A side safety plate 100 is coupled to each of opposite side surfaces of the frame 2c of the stair 2 at a position adjacent to the vertical plate 2b. The side safety plate 100 has a triangular shape and protrudes forwards from the vertical plate 2b.

If the stair 2 does not have the frame 2c, the side safety plates 100 are coupled to respective opposite side surfaces of the vertical plate 2b. If a separate bracket or the like is used, the side safety plates 100 may be coupled to the step board 2a at respective positions adjacent to the vertical plate 2b.

The side safety plate 100 comprises a vertical side 102 which is coupled to the stair 2, and a bottom side 104 and a hypotenuse 106 which are connected to the vertical side 102 to form an approximately triangular shape. The vertical side 102 is oriented in a vertical direction or a direction close to vertical, wherein, for the sake of explanation, the meaning of ‘vertical side’ includes sides which extend in the above-mentioned directions.

The bottom side 104 extends parallel to the step board 2a of the stair 2 from a lower end of the vertical side 102 in a direction away from the stair 2. The hypotenuse 106 extends with an inclination of a predetermined angle from an upper end of the vertical side 102 that is adjacent to the step board 2a and meets the bottom side 104.

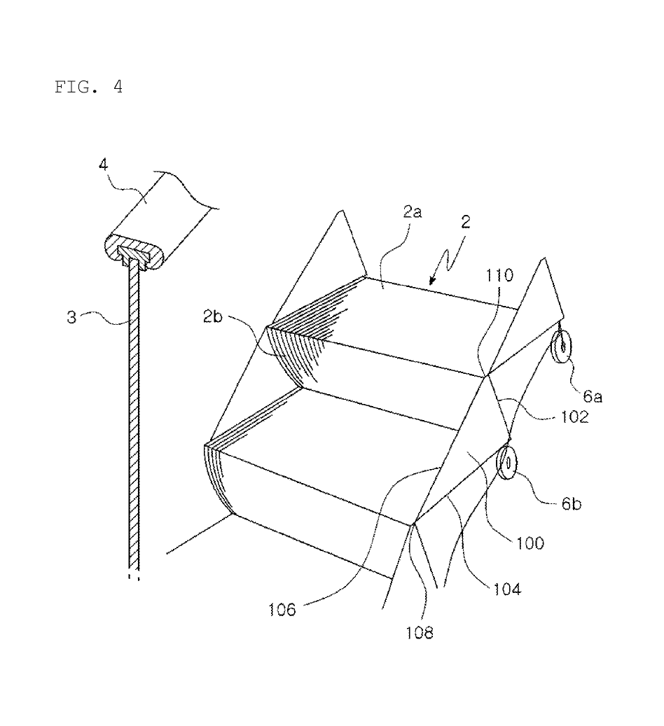

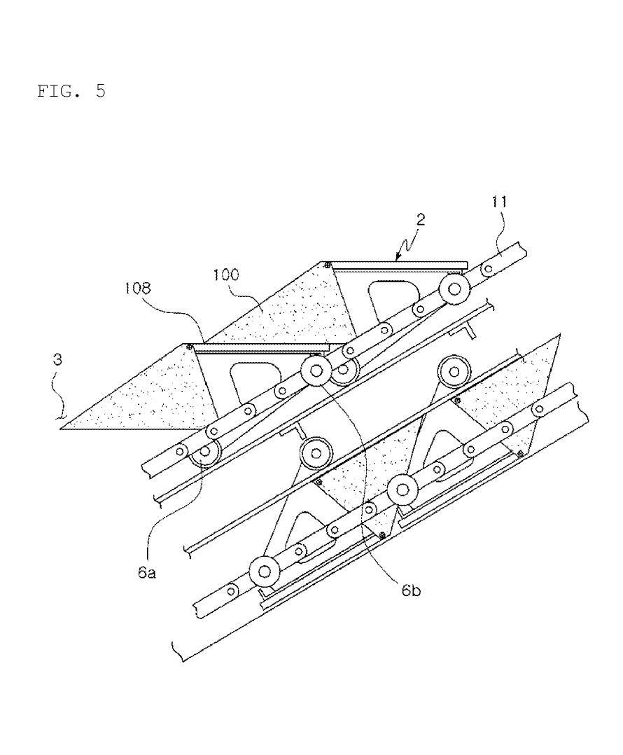

The degree of inclination of the hypotenuse 104 is substantially equal to that of an inclined section of the escalator. This will be explained herein with reference to FIGS. 4 and 5.

Reference numeral 108 denotes a point at which the bottom side 104 meets the hypotenuse 106, thus forming a distal end of the side safety plate 100. Reference numeral 110 denotes an upper end of the side safety plate 100 at which the vertical side 102 and the hypotenuse 106 meet each other. More preferably, the upper end 110 of the side safety plate 100 is formed of a planar portion which is level with the step board 2a of the stair 2.

FIGS. 4 and 5 illustrate an escalator having the above-described escalator stair 2 provided with the side safety device. In FIG. 4, the reference numeral 3 denotes a handrail, and reference numeral 4 denotes a grip. In FIG. 5, reference numeral 11 denotes a chain for transferring stairs 2.

As shown in FIGS. 4 and 5, the side safety plate 100 is configured such that, in the inclined section of the escalator, the bottom side 104 of the side safety plate 100 of each stair 2 is located at a height equal to or slightly higher than the upper surface of the step board 2a of the following stair 2.

The side safety plate 100 extends such that the distal end 108 thereof is spaced apart from a boundary between the step board 2a and vertical plate 2b of the following stair 2 by a predetermined distance. In the inclined section which transfers users, the degree of inclination of the hypotenuse 104 of each side safety plate 100 is almost the same as that of the inclined section.

Due to the above-mentioned construction, the side safety plates 100 cover the sides of the stairs 2. For example, in the case of the downward escalator, even if a child falls over, the side safety plates 100 can prevent the finger of the child from being caught between the step board 2a of the stair 2 and the handrail 3.

Further, in the case of the upward escalator, even if a child falls, the side safety plate 100 can also prevent the finger of the child from being caught between the vertical plate 2b of the stair 2 and the handrail 3.

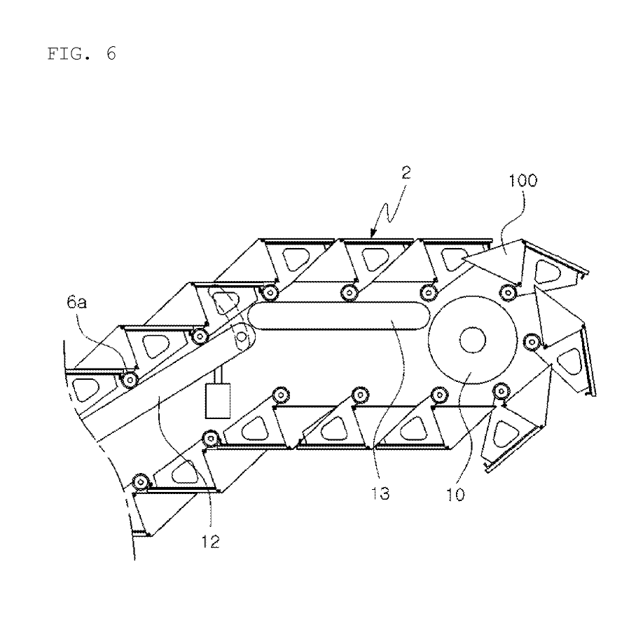

The escalator stairs 2 provided with the side safety devices having the above-mentioned construction circulate in the manner of FIG. 6.

In FIG. 6, reference numeral 10 denotes a drive roll of a drive unit for circulating the stairs 2, reference numeral 12 denotes a rail for transferring the stairs 2 along the inclined section, and reference numeral 13 denotes a rail for transferring the stairs 2 in the horizontal direction.

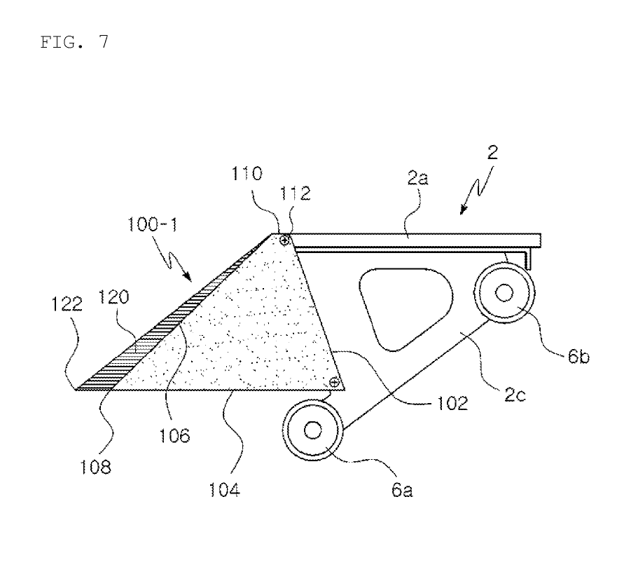

A side safety device according to another embodiment will be described with reference to FIGS. 7 through 10.

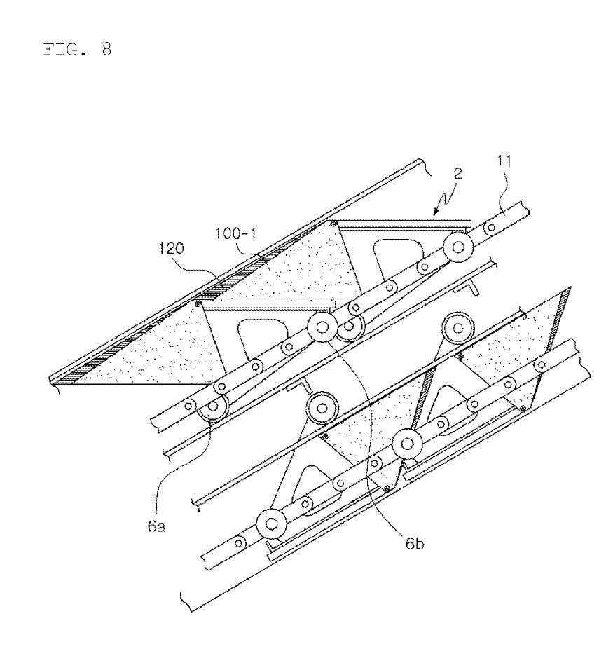

As shown in FIGS. 7 and 8, in the side safety device according to this embodiment, a curved portion 112 is formed in a side safety plate 100-1 at a position adjacent to an upper end 110 thereof, and an elastic deformation member 120 is attached to the side safety plate 100-1 along a hypotenuse 106 thereof. The general construction of the side safety device according to this embodiment is the same as that of the side safety device of FIGS. 2 through 6. The same reference numerals will be used to designate the same elements, and further explanation thereof is deemed unnecessary.

The elastic deformation member 120 has an upper edge which has the same inclination as that of the inclined section of the escalator. As shown in FIG. 8, the upper edge of the elastic deformation member 120 is linear with a constant inclination.

A distal end 122 of the elastic deformation member 120 extends such that it comes into contact with a boundary between the step board 2a and the vertical plate of the following stair 2. Preferably, the distal end 122 of the elastic deformation member 120 extends such that it covers the upper end 110 of the corresponding adjacent side safety plate 100-1.

By virtue of the elastic deformation member 120, the side safety device according to this embodiment can more effectively cover the sides of the stairs 2. That is, space between the step board 2a of each stair 2 and the distal end 108 of the corresponding side safety plate 100-1 is covered with the elastic deformation member 120. Thus, the side safety device according to this embodiment can almost completely eliminate a gap between the step board 2a of each stair 2 and the handrail 3. As a result, this embodiment can more effectively prevent an accident in which, for example, the finger of a child is caught between the stair 2 and the handrail 3.

The elastic deformation member 120 is made of material having at least one characteristic among elasticity, ductility and flexibility. For example, the elastic deformation member 120 is formed of any one among sponge, rubber, elastic resin and brush.

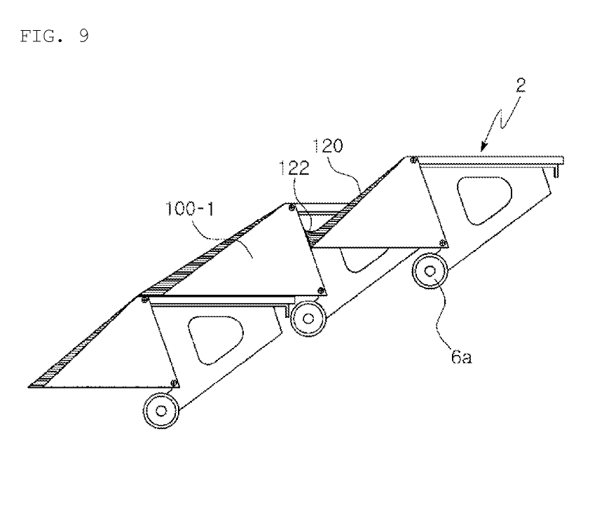

The side safety device according to this embodiment has the following advantages. As shown in FIG. 9, when the escalator is converted from the inclined section into a horizontal section, the distal end 122 of each elastic deformation member 120 overlaps the corresponding adjacent side safety plate 100-1.

If the elastic deformation member 120 is made of hard material, there may be a problem of the elastic deformation member 120 being deformed and becoming unusable. In this embodiment, because the elastic deformation member 120 is made of material having elasticity, ductility and/or flexibility, the distal end 122 of the elastic deformation member 120 can be elastically deformed when it is pressed by the vertical side 102 of the corresponding adjacent side safety plate 100-1. That is, the distal end 122 is elastically deformed in the conversion section, and after the distal end 122 passes through the conversion section, it returns to its original state.

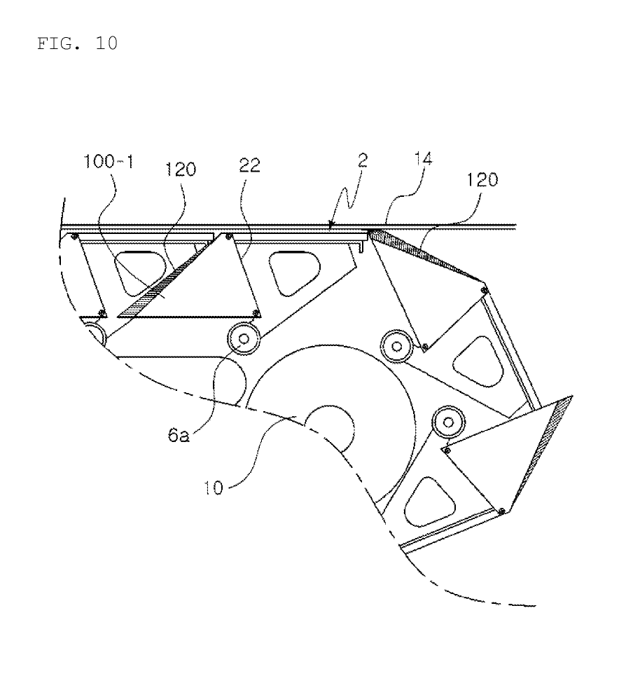

As shown in FIG. 10, when each stair 2 rotates around the drive roll 10, the distal end 122 may come into contact with an escalator platform 14 which covers the stairs 2 of the escalator. If the elastic deformation member 120 is made of hard material, there may also be a problem of the elastic deformation member 120 of being deformed and becoming unusable. In this embodiment, because the elastic deformation member 120 is made of elastic, ductile and/or flexible material, the distal end 122 is elastically deformed when it is pressed by the escalator platform 14. After the elastic deformation member 120 passes through the escalator platform 14, the distal end 122 can return to its original state.

When the side safety device is applied to an escalator, there may be need for an increase in the distance between a lower surface of the escalator platform 14 and the stairs 2, in some cases. However, if the above-mentioned elastic deformation member 120 is used, the side safety device can be applied to the escalator without requiring a change in design of the escalator.

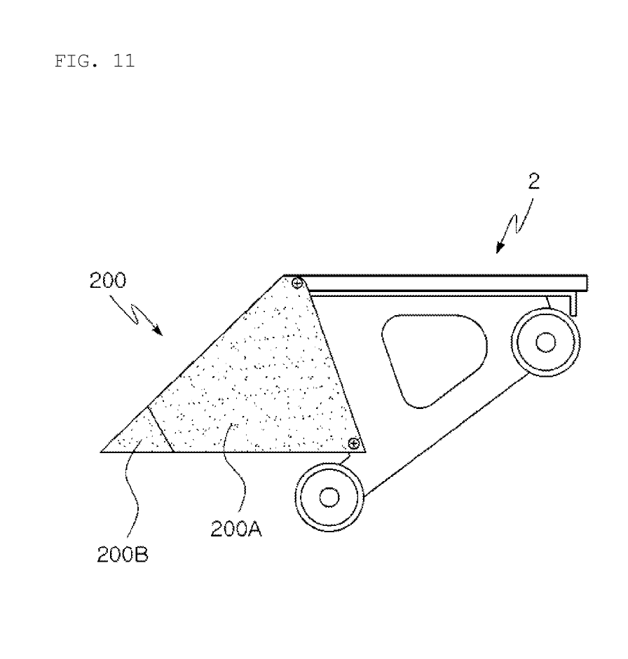

A side safety device according to another embodiment will be described in detail with reference to FIG. 11.

As shown in FIG. 11, a side safety plate 200 according to this embodiment comprises a safety plate body 200A and an elastic deformation body 200B. The entire appearance of the side safety plate 200 is substantially the same as that of the sum of the side safety plate 100-1 and the elastic deformation member 120 of FIG. 7. That is, although it is not shown in the drawing, a distal end of the elastic deformation body 200B extends to the boundary between the step board and the vertical plate of the following stair in the same manner as that of the distal end 122 of the elastic deformation member 120 of the side safety plate 100-1 of FIG. 7. The inclination of the hypotenuse of the side safety plate 200 is substantially the same as that of the inclined section of the escalator.

Meanwhile, the elastic deformation body 200B is made of material having at least one characteristic among elasticity, ductility and flexibility in the same manner as that of the above-mentioned elastic deformation member 120. The elastic deformation body 200B is preferably fastened to the safety plate body 200B by bonding or the like.

The side safety plate 200 comprising the safety plate body 200A and the elastic deformation body 200B according to this embodiment can more effectively cover the corresponding side of the stair. Further, in the side safety plate 200 according to this embodiment, the elastic deformation body 200B can be elastically deformed in the same manner as that of the elastic deformation member 120 illustrated with reference to FIGS. 9 and 10. The construction of this embodiment can also be effectively applied to the escalator.

Meanwhile, unlike this embodiment, the entirety of the side safety plate 200 may be made of material which can be elastically deformed. In this case, material which can be elastically deformed while maintaining appropriate strength must be used.

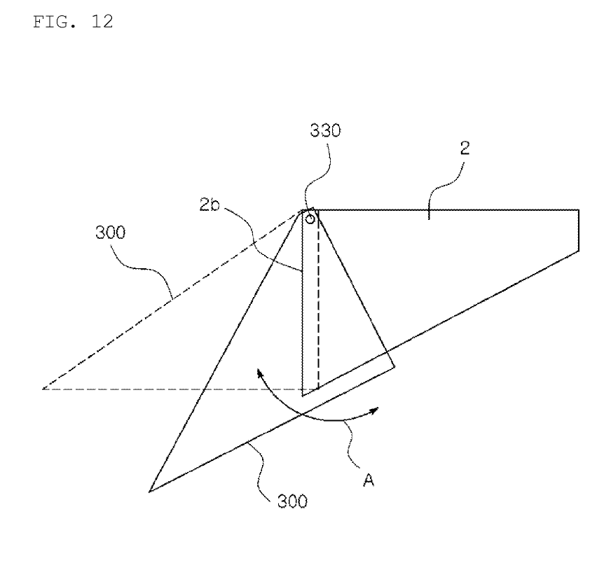

The operation of the side safety device according to another embodiment will be explained with reference to FIG. 12.

In the embodiment of FIG. 12, the side safety plate 300 of the side safety device is configured such that it can rotate with respect to the vertical plate 2b of the stair 2 around a point adjacent to the upper end of the side safety plate 300. The side safety plate 300 can rotate around this point in a clockwise or counterclockwise direction along the arrow A of FIG. 12.

The upper end of the side safety plate 300 is coupled to the stair 2 by a hinge shaft 330. The side safety plate 300 can rotate around the hinge shaft 300 with respect to the vertical plate 2b of the stair 2.

Although the side safety plate 300 and the stair 2 of the side safety device of FIG. 12 are very schematically illustrated for the sake of explanation, the general constructions of the side safety plate 300 and the stair 2 are substantially the same as those of the forgoing embodiments.

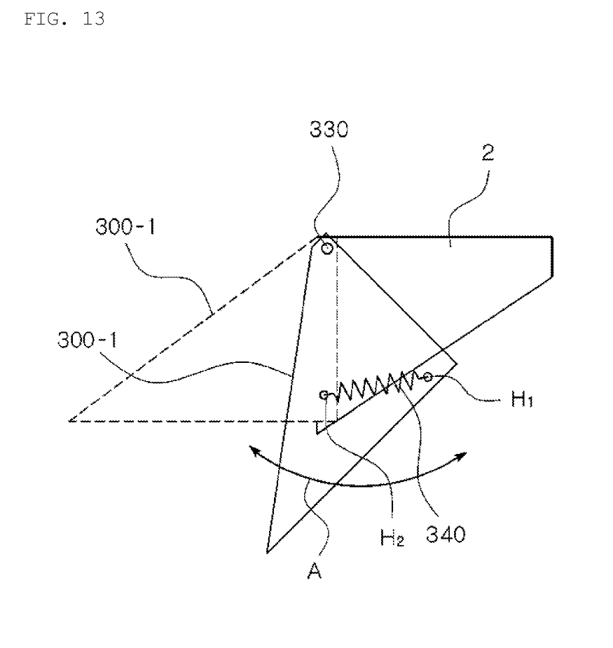

A detailed example pertaining to this will be explained with reference to FIG. 13.

As shown in FIG. 13, a side safety plate 300-1 is rotatably coupled at an upper end thereof to the stair 2 by a hinge shaft 330. A lower end of the side safety plate 300-1 is elastically connected by a spring 140 to a lower portion of the stair 2 that is adjacent to the vertical plate. For this, a coupling hole H1 is formed in the lower end of the side safety plate 300-1 that is adjacent of the stair 2, and a coupling hole H2 that corresponds to the coupling hole H1 is formed in the lower portion of the stair 2.

A first end of the spring 140 is connected to the coupling hole H1 of the side safety plate 300-1, and a second end thereof is connected to the coupling hole H2 of the stair 2. The side safety plate 300-1 can rotate around the hinge shaft 330 by a predetermined angle with respect to the vertical plate of the stair 2. In other words, the side safety plate 300-1 can rotate in the clockwise or counterclockwise direction by a predetermined angle along the arrow A of FIG. 13.

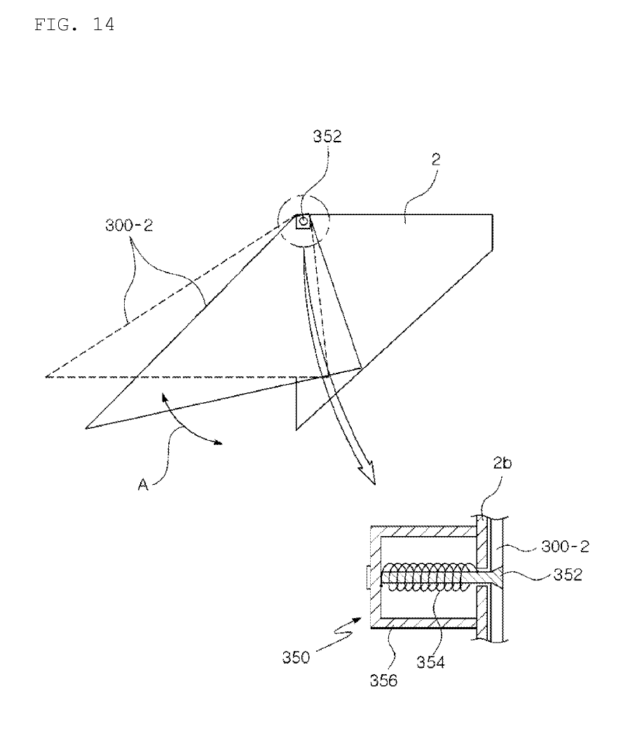

Another detailed example will be explained with reference to FIG. 14.

As shown in FIG. 14, a side safety plate 300-2 is rotatably coupled at an upper end thereof to the stair 2 by an elastic hinge unit 350.

The elastic hinge unit 350 comprises a hinge shaft 352, a spring 354 and a bracket 356. A first end of the hinge shaft 352 is fastened to the side safety plate 300-2, and a second end thereof is rotatably supported on the bracket 356. A first end of the spring 354 is fastened to the hinge shaft 352, and a second end thereof is fastened to the bracket 356. The bracket 356 is fastened to the vertical plate 2a of the stair 2. Meanwhile, the bracket 356 may be coupled to the step board or the frame 2c (refer to FIG. 3) of the stair 2 in lieu of the vertical plate 2a.

In this construction, although the side safety plate 300-2 can rotate relative to the vertical plate of the stair 2, it is limited by the spring 354 such that it rotates within a predetermined angular range. That is, the side safety plate 300-2 can rotate in the clockwise or counterclockwise direction by a predetermined angle along the arrow A of FIG. 14.

The elastic hinge unit 350 may be configured in such a way that the hinge shaft 352 is fastened to the bracket 356 and is rotatably coupled to the side safety plate 350-2. The first end of the spring 354 is directly fastened to the side safety plate 350-2, and the second end thereof is fastened to the hinge shaft 352 or the bracket 356.

The construction of the side safety plate 300, 300-1 or 300-2 of FIG. 12, 13 or 14 can be effectively operated when the stair is located at a position of FIG. 10.

In detail, if the distance between the stair 2 and the escalator platform (14, refer to FIG. 10) is comparatively short, when each stair 2 rotates around the drive roll, the distal end of the side safety plate 300, 300-1 or 300-2 of the stair 2 may come into contact with the lower surface of the escalator platform (14, refer to FIG. 10). At this time, because the side safety plate 300, 300-1, 300-2 rotates relative to the vertical plate of the stair 2, the stair 2 can easily rotate around the drive roll.

The side safety plate 300, 300-1 or 300-2 can be directly used in an escalator without requiring a change in design of the escalator.

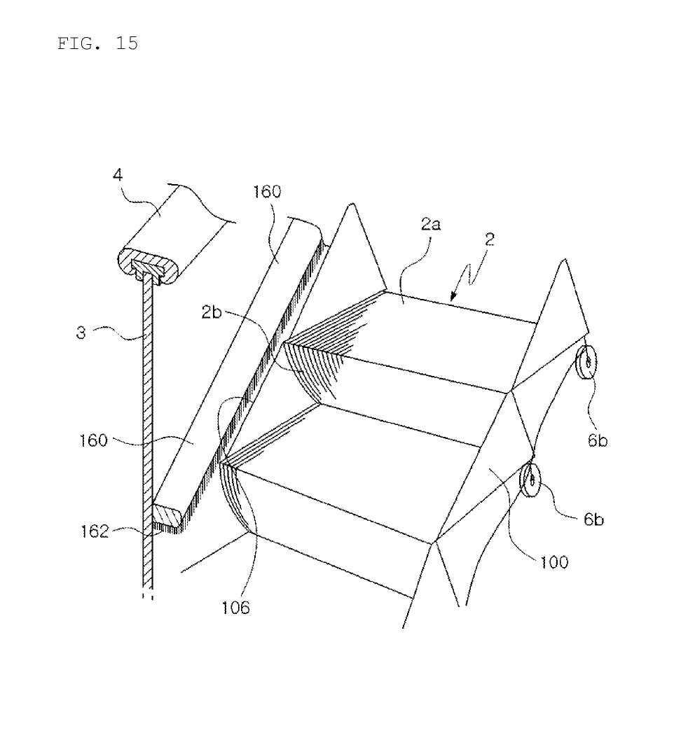

Another embodiment of the escalator having the side safety device will be described in detail with reference to FIG. 15.

As shown in FIG. 15, the general construction of this embodiment, other than the facts that a skirt guard 160 is provided on each handrail 3 and an elastic deformation member 162 is attached to a lower surface of the skirt guard 160, is the same as that of the embodiment of FIG. 4. The same reference numerals will be used to designate the same elements, and further explanation thereof is deemed unnecessary.

The skirt guard 160 protrudes from an inner surface of the handrail 3 towards the stairs 2 and extends along the inclined section of the escalator. A bottom surface of the skirt guard 160 is disposed above each of opposite side edges of the stairs 2.

The bottom surface of the skirt guard 160 is located adjacent to the hypotenuses 106 of the side safety plates 100 and is oriented at substantially the same inclination as that of the hypotenuses 106. Of course, in lieu of the side safety plate 100 of FIG. 15, if the side safety plate 100-1 of FIG. 7 or the side safety plate 200 of FIG. 11 is used, the bottom surface of the skirt guard 160 may have an inclination which is completely equal to that of the hypotenuses of the side safety plates.

The elastic deformation member 162 is made of material having at least one characteristic among elasticity, ductility and flexibility. For example, the elastic deformation member 162 is formed of any one among sponge, rubber, elastic resin and brush.

The skirt guard 160, in cooperation with the side safety plates 100, can more effectively prevent an accident in which the finger of a user is caught between the stair 2 and the handrail 3.

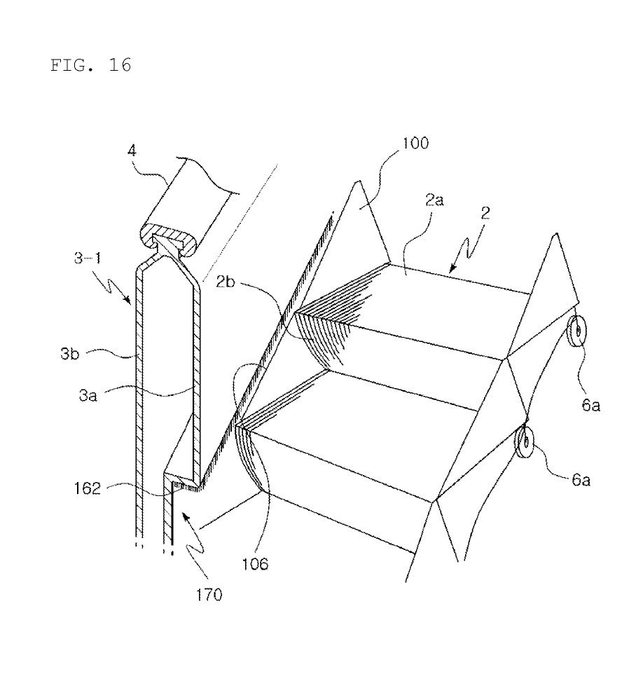

Another embodiment of the escalator having the side safety device will be described in detail with reference to FIG. 16.

As shown in FIG. 16, the general construction of this embodiment, other than the facts that a handrail 3 comprises an inner plate 3a and an outer plate 3b, a skirt depression 170 is formed in a lower portion of the inner plate 3a, and an elastic deformation member 162 is attached to a lower surface of the skirt depression 170, is the same as that of the embodiment of FIG. 4. The same reference numerals will be used to designate the same elements, and further explanation thereof is deemed unnecessary.

The skirt depression 170 is depressed from the stairs 2 towards the outer plate 3b. The lower surface of the skirt depression 170 is disposed above corresponding one of opposite side edges of the stairs 2.

The lower surface of the skirt depression 170 is located adjacent to the hypotenuses 106 of the side safety plates 100 and is oriented at substantially the same inclination as that of the hypotenuses 106. In lieu of the side safety plate 100 of FIG. 16, if the side safety plate 100-1 of FIG. 7 or the side safety plate 200 of FIG. 11 is used, the lower surface of the skirt depression 170 may have an inclination which is completely equal to that of the hypotenuses of the side safety plates.

The elastic deformation member 162 is made of material having at least one characteristic among elasticity, ductility and flexibility. For example, the elastic deformation member 162 is formed of any one among sponge, rubber, elastic resin and brush.

The skirt depression 170, in cooperation with the side safety plates 100, can more effectively prevent an accident in which the finger of a user is caught between the stair 2 and the handrail 3.

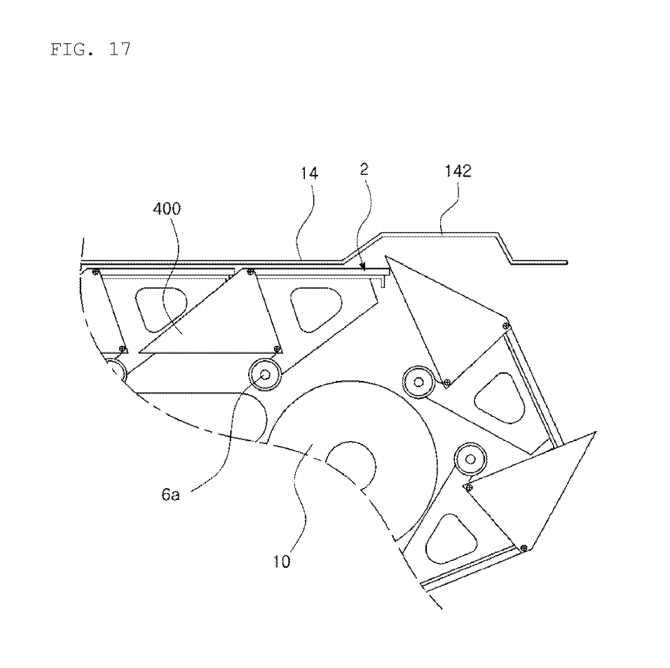

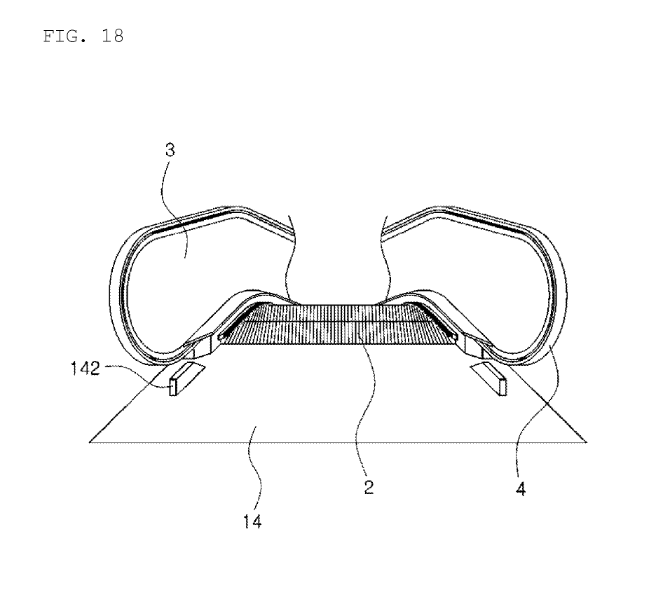

Referring to FIGS. 17 and 18, a side safety device according to an embodiment of the invention comprises a side safety plate 400 and safety-plate-receiving-space defining parts 142 which are provided in the escalator platform 14.

The side safety plate 400 is an integral triangular plate and has substantially the same shape as that of the side safety device 100 of FIG. 3. Explanation of the construction of the side safety plate 400 refers to the above-mentioned description of the construction of the side safety plate 100, and further explanation thereof is deemed unnecessary.

Each safety-plate-receiving-space defining part 142 is formed by protruding a portion of the escalator platform 14 upwards based on the drawing in such a way that a space is defined therein. That is, if the safety-plate-receiving-space defining part 142 is not provided, when the stairs 2 rotates around the drive roll 10, the distal ends of the side safety plates 400 may come into contact with the lower surface of the escalator platform 14 which covers the stairs 2 of the escalator. In this embodiment, the safety-plate-receiving-space defining part 142 is provided so that when the side safety plates 400 rotate around the drive roll 10, the distal ends of the side safety plates 400 can be prevented from coming into contact with the lower surface of the escalator platform 14.

Although the safety-plate-receiving-space defining parts 142 protrude from the escalator platform 14 upwards, they are disposed on opposite side portions of the escalator platform 14 below the respective rail grips 4. The safety-plate-receiving-space defining parts 142 do not impede the walking of users.

As described above, the invention can achieve the purpose of preventing an accident while minimizing a change in the structure of the existing escalator.

Although preferred embodiments have been disclosed for illustrative purposes, those skilled in the art will appreciate that various modifications, additions and substitutions are possible, without departing from the scope and spirit of the invention as disclosed in the accompanying claims.

1. A side safety device for an escalator in which a plurality of stairs circulate, the side safety device comprising:
a side safety plate coupled to each of side surfaces of each of the stairs at a position adjacent to a vertical plate of the stair, the side safety plate having a triangular shape and protruding forwards from the vertical plate,
wherein the side safety plate having the triangular shape comprises a bottom side extending parallel to a step board of the stair in a direction away from the stair, and a hypotenuse extending at a predetermined inclination so as to meet the bottom side, and
the inclination of the hypotenuse is substantially equal to an inclination of an inclined section of the escalator.

2. The side safety device of claim 1, wherein in the inclined section of each of the stairs, the bottom side is level with an upper surface of the step board of the following stair adjacent to the vertical plate of the stair.

3. The side safety device of claim 1, wherein the side safety plate extends such that a distal end of the side safety plate is disposed at a position spaced apart from a boundary between the step board and the vertical plate of the following stair by a predetermined distance.

4. The side safety device of claim 1, further comprising
an elastic deformation member provided on an upper end of the side safety plate, the elastic deformation member extending along the hypotenuse,
wherein an inclination of an upper surface of the elastic deformation member is equal to an inclination of the inclined section of the escalator.

5. The side safety device of claim 4, wherein the elastic deformation member is made of material having at least one characteristic among elasticity, ductility and flexibility.

6. The side safety device of claim 1, wherein a distal end of the side safety plate extends to a boundary between the step board and the vertical plate of the following stair adjacent to the vertical plate of the stair.

7. The side safety device of claim 6, wherein the side safety plate is made of material having at least one characteristic among elasticity, ductility and flexibility.

8. The side safety device of claim 1, wherein the side safety plate is provided so as to be rotatable relative to the vertical plate of the stair by a predetermined angle around a point adjacent to an upper end thereof at which the bottom side and the hypotenuse meets.

9. The side safety device of claim 8, further comprising:
a shaft connecting the side safety plate rotatably to the vertical plate of the stair at the point adjacent to the upper end of the side safety plate; and
a spring elastically connecting the side safety plate to the vertical plate of the stair at a position adjacent to the bottom side of the side safety plate.

10. The side safety device of claim 8, further comprising:
a shaft fastened to the side safety plate to rotatably connect the side safety plate to the stair at the point adjacent to the upper end of the side safety plate; and
a spring fastened at a first end thereof to the side safety plate and fastened at a second end thereof to the stair so that the side safety plate is elastically connected to the stair by the spring.

11. The side safety device of claim 1, further comprising
a skirt guard protruding from an inner surface of a handrail towards the stairs and extending along the inclined section,
wherein the skirt guard extends at an inclination equal to the inclination of the hypotenuse in such a way that a bottom surface of the skirt guard is adjacent to the hypotenuse of the side safety plate.

12. The side safety device of claim 1, further comprising
a skirt depression formed in an inner surface of a handrail towards an outer surface of the handrail, the skirt depression extending along the inclined section,
wherein the skirt depression extends at an inclination substantially equal to the inclination of the hypotenuse in such a way that a top surface of the skirt guard is adjacent to the hypotenuse of the side safety plate.

13. The side safety device of claim 1, further comprising
a safety-plate-receiving-space defining part formed by protruding a portion of an escalator platform upwards in such a way that space is defined in the safety-plate-receiving-space defining part, whereby a distal end of the side safety plate that rotates for circulation along with the stair around a roll under the escalator platform is prevented from coming into contact with a lower surface of the escalator platform.

14. An escalator, comprising:
a plurality of stairs rotating in a circulation belt manner between upper and lower rollers having a height difference; and
the side safety device according to claim 1.
